(19) United States
(12) Patent Application Publication
(10) Pub. No.: US 2017/0292054 A1
(43) Pub. Date: Oct. 12, 2017

(54) Graphene heat dissipation baking varnish

(71) Applicant: BGT MATERIALS LIMITED, Manchester (GB)

(72) Inventors: Chung-Ping LAI, Hsinchu County (TW); Kuo-Hsin CHANG, Chiayi County (TW); Jia-Cing CHEN, Tainan City (TW)

(21) Appl. No.: 15/630,226

(22) Filed: Jun. 22, 2017

Related U.S. Application Data
(63) Continuation-in-part of application No. 14/990,807, filed on Jan. 8, 2016.

(51) Int. Cl. C09K 5/14; C23C 26/00; C09D 129/04; C09D 1/00; C09D 5/00

(52) U.S. Cl. CPC C09K 5/14; C09D 1/00; C09D 5/00; C09D 129/04; C23C 26/00

(57) ABSTRACT

A highly porous heat dissipation coating by graphene-rich baking varnish consists of: graphene nanoflakes, at least one dispersants, binders, and carriers. The amount of graphene-rich nanoflakes accounts for 10 to 70 wt % of solid composition of a graphene baking varnish. The at least one dispersant is non-ionic or ionic dispersant. The binder is made of thermoplastic polymers. The carrier is selected from aqueous liquids, organic solvents, or a combination thereof. A post-baking treatment at relative high temperature (100 to 400° C.) is applied for enhancing the adhesion of heat dissipation coating on metal surface. Accordingly, the graphene-rich baking varnish enhances adhesion and improves heat dissipation rate by convection and radiation.

### BACKGROUND OF THE INVENTION

This application is a Continuation-in-Part of application Ser. No. 14/990,807, filed Jan. 8, 2016.

### Field of the Invention

The present invention relates to a graphene-rich baking varnish for metal surface coating which enhances adhesion of coating and improves the heat dissipation rate of metal by thermal convection and radiation. The standing flakes and porous coating on metal surface by graphene-rich baking varnish are considered as micro fin to enhance surface convection & radiation.

### Background of the Invention

Paint consisted of plastic binder, color filler, various additives, and solvent. It was widely used everywhere for beautiful appearance and surface protection function.

For example, paints on metal surface were used to avoid the oxidation, corrosion, and aging of metal.

However, plastic binders and color fillers in paints are electronic and heat insulation. Such plastic paints on metal surface will significantly obstruct the heat dissipation of metal from surface to surroundings.

Graphene, successfully discovered by Andre Geim and Konstantin Novoselov in 2004, has outstanding properties such as high thermal and electric conductivity as well as high surface area. Both properties indicate graphene to be a promising candidate of heat-spreading solution.

Using graphene as filler of paint was disclosed in some inventions.

However, the percentage of graphene filler is still relatively low that confines the performance enhancement of graphene in heat dissipation application.

For example, CN 102964972B disclosed an epoxy-based graphene paint was proposed for heat dissipation coating. There is only 0.18˜1.8 wt % graphene in paint.

Other epoxy-based graphene paint was taught in CN 103059636A and was also proposed for car. Less 10 wt % graphene was used in total solid of paint.

0.1˜5wt % graphene solid in non-stick coating was disclosed in CN 103214897B. After coating, 400° C. heat treatment was applied.

Other acrylic-based graphene paint disclosed in CN 103468101A was proposed for heat dissipation coating. There is only 5.9˜7.4 wt % graphene in paint solid.

Less 5wt % graphene/diamond mixture was used in heat dissipation paste as disclosed in CN103627223A.

0.8˜4.2 wt % graphene was disclosed in CN 104109450A and was used in total solid composition of anti-corrosion painting.

5 wt % graphene flake in PEDOT-PSS conductive polymer was disclosed in U.S. 2010/0000441 A1 to enhance the thermal conductivity of graphene-polymer composite.

The idea in these inventions was to use relatively small

amount of graphene, and graphene was considered as an auxiliary filler for paint.

Primary color fillers and plastic binders are still the main components. They are heat insulators, which confine the effect of graphene on performance improvement.

As illustration in FIGS. 1 and 2, graphene flake was used as an auxiliary filler for paint. Large amount of heat insulator plastic binders and color fillers in paint results in a poor heat conduction of coating.

As shown in FIGS. 1 and 2, numerical reference 10 denotes a metal surface, numerical reference 11 represents paint with low content of graphene flake, numerical reference 12 designates large amount of plastic binders and color fillers, and numerical reference 13 indicates graphene flake, wherein the graphene flake 13 was used as auxiliary filler for paint, and the large amount of plastic binders and color fillers 12 in paint results in a poor heat conduction of coating. In addition, the coating from such binder-rich and color filler-rich paint is a dense layer, which obstruct the surface convection & radiation of paint.

Therefore, using such paint will limit the heat dissipation of metal from surface to surroundings.

The present invention has arisen to mitigate and/or obviate the afore-described disadvantages.

### SUMMARY OF THE INVENTION

The primary objective of the present invention is to provide a graphene-rich baking varnish which enhances adhesion and improves heat dissipation rate by convection and radiation.

To obtain above-mentioned objective, a graphene-rich baking varnish provided by the present invention consists of: graphene nanoflakes, at least one dispersants, binders, and carriers.

The solid content of graphene-rich baking varnish is 10 to 70 wt %.

The amount of graphene nanoflakes accounts for 10 to 70 wt % of solid composition of a graphene-rich baking varnish.

The at least one dispersant is non-ionic or ionic dispersant.

The binder is made of thermoplastic polymers, such as polyvinyl acetate, acrylic resin, acrylonitrile butadiene styrene (ABS), polycarbonate (PC), polyethylene (PE), polyetheretherketone (PEEK), polypropylene (PP), polystyrene, polyamide, polyvinylidene difluoride (PVDF), polyvinyl chloride (PVC), polytetrafluoroethylene (PTFE), and so on.

The carrier is selected from aqueous liquids, organic solvents, or a combination thereof. For example, carrier can be water for aqueous paint, or dimethylformamide (DMF) for organic paint, or the mixture solution of water and DMF.

Preferably, a thickness of the graphene nanoflakes ranges from 1 to 100 nm, and a size of the graphene nanoflakes is from 0.1 to 100 μm.

Preferably, the at least one dispersant is added at 1 to 10 wt % of the solid composition of the graphene-rich baking varnish.

Preferably, the binder is accounted for 10 to 85 wt % of the solid composition of the graphene-rich baking varnish.

Preferably, the carriers are aqueous liquids or organic solvents, and the carrier accounts for 30 to 90 wt % of total composition of the graphene-rich baking varnish.

Preferably, the graphene-rich baking varnish is coated on metal surface in any one of screen printing, spraying, dipping, and pasting manners.

### BRIEF DESCRIPTION OF THE DRAWINGS

FIG. 1 is a schematic view illustrating graphene flake was used as auxiliary filler for paint.

FIG. 2 is an amplified schematic view of a portion A of FIG. 1 illustrating large amount of heat insulator plastic binders and color fillers in paint results in a poor heat conduction of coating.

FIG. 3 is a schematic view illustrating graphene flake was used as primary filler for paint according to a preferred embodiment of the present invention.

FIG. 4 is an amplified schematic view of a portion B of FIG. 3 illustrating large amount of heat conductive graphene nanoflakes in paint results in a high heat dissipation performance coating on metal surface according to the preferred embodiment of the present invention.

FIG. 5 is a SEM image of binder-rich graphene baking varnish coated on metal surface.

FIG. 6 is a SEM image of graphene-rich graphene baking varnish coated on metal surface.

FIG. 7 is a SEM image of commercial black paint coated on metal surface.

FIG. 8 shows Table 1, in which the heat dissipation test of Cu metal with various coating according to the preferred embodiment of the present invention.

FIG. 9 shows Table 2, in which the solid composition of various graphene-based polymer composition painting.

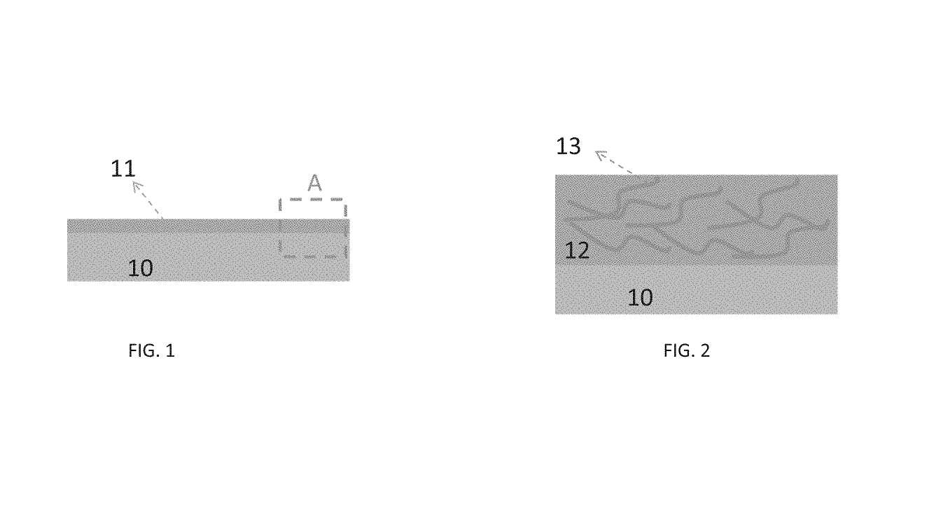

### DETAILED DESCRIPTION OF THE PREFERRED EMBODIMENTS

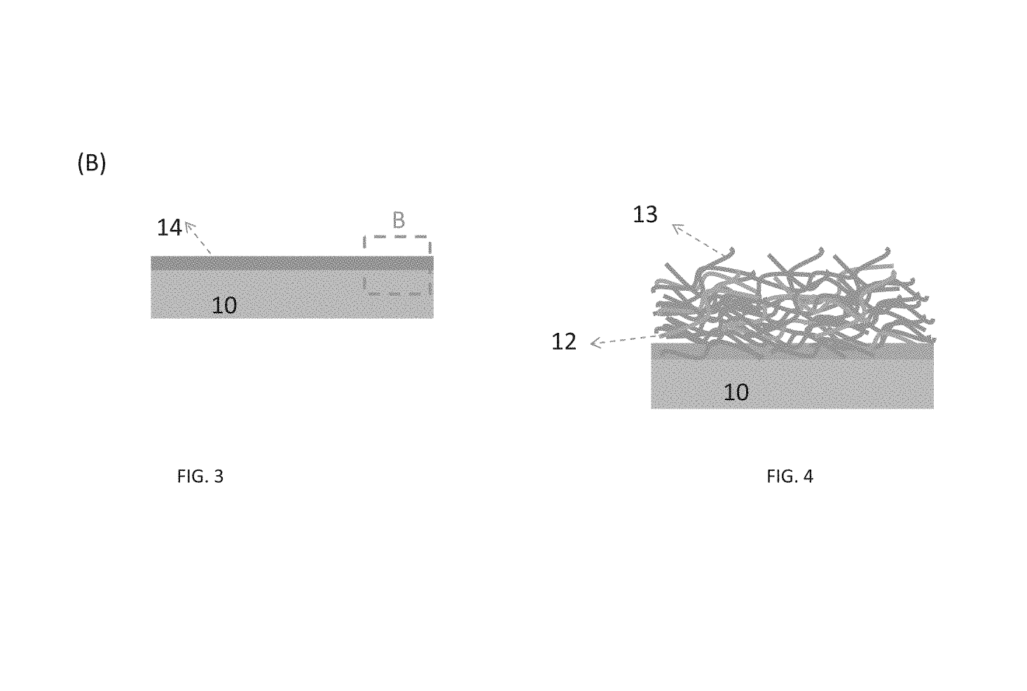

As illustration in FIGS. 3 and 4, numerical reference 10 denotes a metal surface, numerical reference 12 designates plastic binders and color fillers, numerical reference 13 indicates graphene flake, and numerical reference 14 represents paint with high content of graphene flakes, wherein an amount of graphene flakes 13 is raised and content of plastic binders and color fillers 12 is reduced in paint so as to form a porous graphene flake coating layer, thus overcoming the above issue in heat dissipation paint.

In such architecture of graphene-rich baking varnish, porous graphene flake layer can play as a role of micro fin to enlarge the contact area to surroundings and improve the heat dissipation rate by convection and radiation. So compared to binder-rich and color filler-rich paint, graphene-rich paint exhibits high heat conductivity and supplies a more smooth heat conduction pathway.

However, the adhesion of graphene-rich coating layer will become terrible when we reduce the content of plastic binders. For example, some graphene-rich baking varnish coating will be peeled off by tape before baking treatment.

In order to enhance the adhesion of the graphene flakes 13, we need to use thermoplastic polymers as binders. And a baking treatment at relatively high temperature (100 to 400° C.) is requested after coating.

At relatively high baking temperature, the well-mixed thermoplastic binders in coating layer of graphene mixture will soften and flow down along the graphene flakes 13 to the metal surface 10, which not only can enhance the adhesion of the graphene paint 14 in relatively low binder content but also form a protection film on the metal surface 10.

Therefore, a method of enhancing adhesion of the graphene-rich paint 14 contains steps of:

1). coating graphene-rich baking varnish on a surface of the metal 10;

2). drying and baking graphene-rich paint at relatively high temperature (100 to 400° C.); and

3). cooling to a room temperature to form an uniform graphene-rich baking varnish.

Thereby, the graphene-rich baking varnish after baking at relatively high temperature don't be peeled off by the tape.

In this invention, using thermoplastic polymers as binder of the graphene-rich baking varnish and post-baking treatment at relative high temperature (100 to 400° C.) are disclosed for enhancing the adhesion of heat dissipation coating on metal surface.

The graphene-rich baking varnish consists of graphene nanoflakes, at least one dispersants, binders, and carriers.

The solid content of graphene-rich baking varnish is 10 to 70 wt %.

The primary material for thermal dissipation and radiation is the graphene nanoflakes, wherein a thickness of the graphene nanoflakes ranges from 1 to 100 nm, and a size of the graphene nanoflakes is from 0.1 to 100 μm, wherein the amount of graphene nanoflakes accounts for 10 to 70 wt % of solid composition of the graphene-rich baking varnish.

The at least one dispersant is non-ionic or ionic dispersant and is added at 1 to 10 wt % of the solid composition of the graphene-rich baking varnish.

The binder is made of thermoplastic polymers and is accounted for 10 to 85 wt % of the solid composition of the graphene-rich baking varnish.

The carrier is selected from aqueous liquids, organic solvents, or a combination thereof, which depends on what thermoplastic binders were used.

The carrier accounts for 30 to 90 wt % of total composition of the graphene-rich baking varnish.

Preferably, the graphene-rich baking varnish is coated on metal surface in any one of screen printing, spraying, dipping, and pasting manners.

Preferably, a post-baking treatment at relative high temperature (100 to 400° C.) is applied for enhancing the adhesion of heat dissipation coating on metal surface.

### EXAMPLE 1

### Binder-Rich Graphene Baking Varnish

A binder-rich graphene baking varnish was used as a example for heat dissipation coating of metal surface. This binder-rich graphene baking varnish consists of 90 g water, 1.5 g BYK disperbyk-191 dispersant, 15 g graphene flake, 75 g polyvinyl acetate binder. So there is 82.0 wt % binder resin, 16.4 wt % graphene flake, 1.6 wt % dispersant in the solid composition. The binder-rich graphene baking varnish was sprayed on the Cu foil surface and dried at 100° C. to form a uniform coating. After drying, the sample was baked at 200° C. for 30 min to enhance the adhesion of baking varnish on metal surface.

### EXAMPLE 2

### Graphene-Rich Baking Varnish

A graphene-rich graphene baking varnish was used to enhance the heat dissipation ability for metal surface coating. This graphene-rich graphene baking varnish consists of 60 g water, 1.2 g BYK disperbyk-191 dispersant, 12 g graphene flake, 5 g polyvinyl acetate binder. So there is 27.5 wt % binder resin, 65.9 wt % graphene flake, 6.6 wt % dispersant in the solid composition. The graphene-rich graphene baking varnish was sprayed on the Cu foil surface and dried at 100° C. to form a uniform coating. After drying, the sample was baked at 200° C. for 30 min to enhance the adhesion of baking varnish on metal surface.

### COMPARATIVE EXAMPLE 1

### Commercial Black Painting

The commercial Telox 109 black paint was used as a comparative example to show the advantages of graphene baking varnish. This commercial black paint consists of carbon black filler, acrylic resin, dimethyl ether solvent, and other additives. Due to the commercial black paint already exhibited a very good adhesion on the surface Cu metal, no any further baking treatment was applied for this sample.

### COMPARATIVE EXAMPLE 2

### White Ceramic Painting

A white ceramic baking varnish was used as a comparative example to show the advantages of graphene baking varnish. This white ceramic baking varnish consists of 60 g water, 1.2 g BYK disperbyk-191 dispersant, 12 g boron nitride (BN) flake, 5 g polyvinyl acetate binder. So there is 27.5 wt % binder resin, 65.9 wt % BN flake, 6.6 wt % dispersant in the solid composition. The white ceramic baking varnish was sprayed on the Cu foil surface and dried at 100° C. to form a uniform coating. After drying, the sample was baked at 200° C. for 30 min to enhance the adhesion of baking varnish on metal surface.

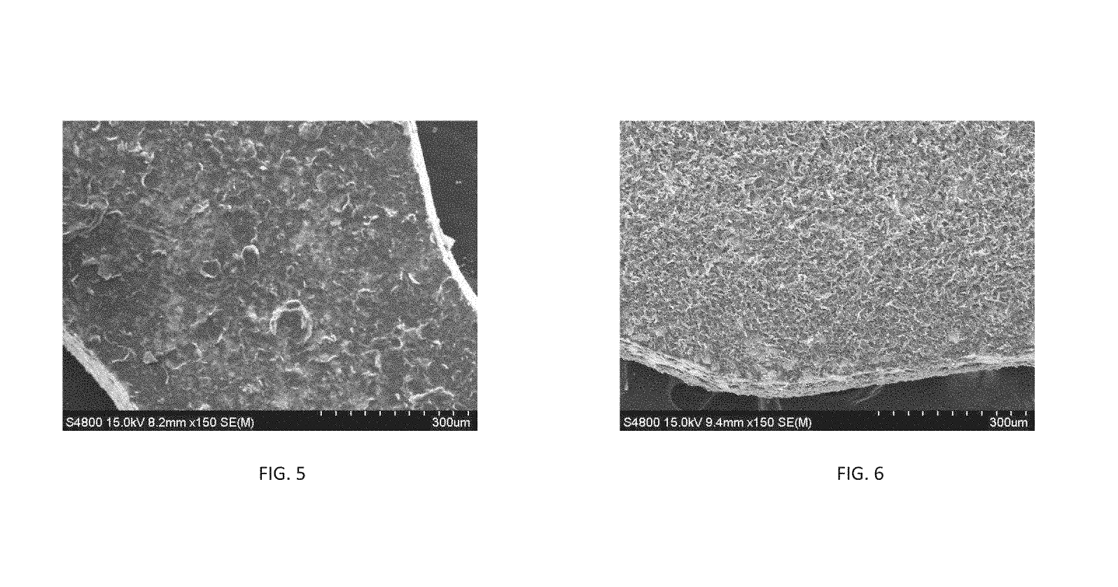

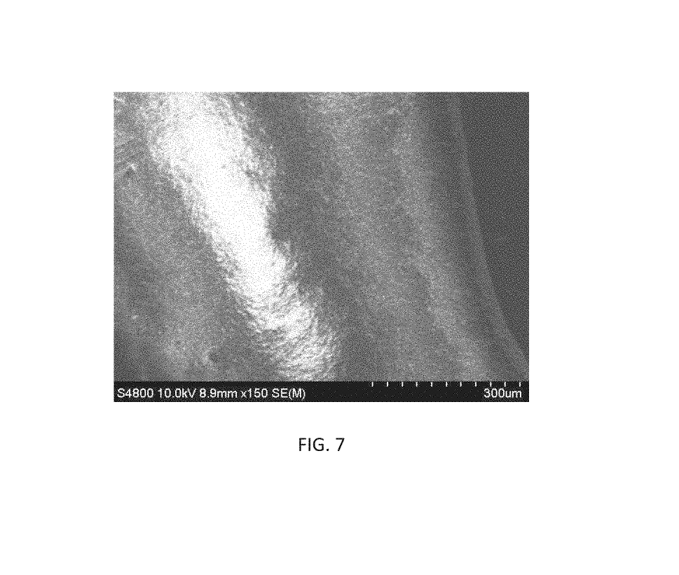

SEM surface morphologies of example 1, 2, and comparative example 1 were observed. From the comparison between FIG. 5, FIG. 6 and FIG. 7, the metal surface coated by graphene-rich baking varnish exhibits a highly porous morphology (example 2, FIG. 6); however, a smooth and dense surface was observed for binder-rich graphene baking varnish (example 1, FIG. 5) and commercial black paint (comparative example 1, FIG. 7).

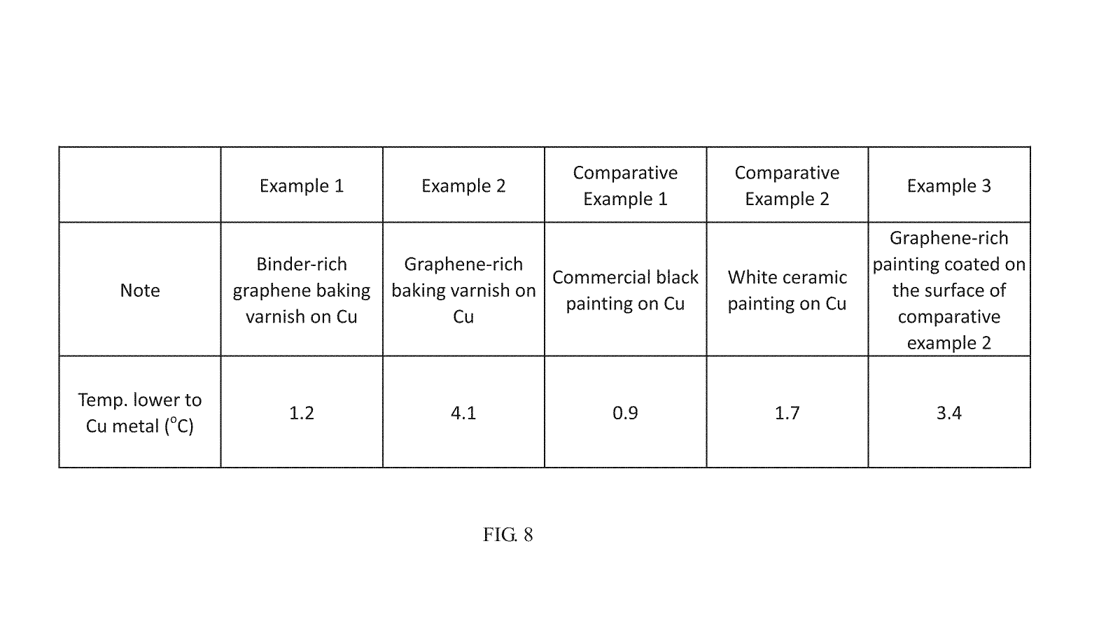

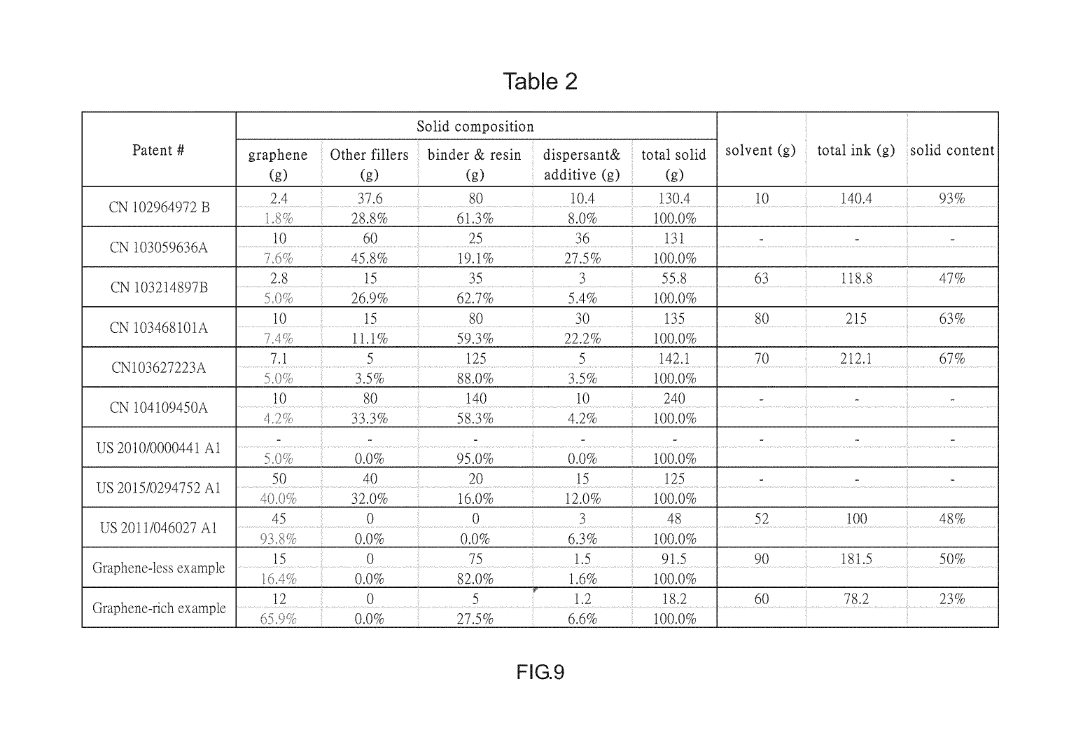

From the heat dissipation ability of all sample in FIG. 8, graphene-rich baking varnish shows the highest temperature cooling of Cu metal. In addition, coating graphene baking varnish on the surface of ceramic varnish can further enhance its heat dissipation rate. The high heat dissipation performance of graphene-rich baking varnish is attributable to that the porous architecture can raise the heat dissipation rate by both thermal convection and radiation, which is totally different to prior arts.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A graphene-rich baking varnish consists of: graphene nanoflakes, at least one dispersants, binders, and carriers;
wherein the solid content of graphene-rich baking varnish is 10 to 70 wt %;
wherein the amount of graphene nanoflakes accounts for 10 to70 wt % of solid composition of a graphene-rich baking varnish;
wherein the at least one dispersant is non-ionic or ionic dispersant;
wherein the binder is made of thermoplastic polymers; and
wherein the carrier is selected from aqueous liquids, organic solvents, or a combination thereof;

2. The graphene-rich baking varnish as claimed in claim 1, wherein the at least one dispersant is added at 1 to 10 wt % of the solid composition of the graphene-rich baking varnish.

3. The graphene-rich baking varnish as claimed in claim 1, wherein the binder is accounted for 10 to 85 wt % of the solid composition of the graphene-rich baking varnish.

4. The graphene-rich baking varnish as claimed in claim 1, wherein the carrier accounts for 30 to 90 wt % of the total composition of a graphene-rich baking varnish.
